(19) United States
(12) Patent Application Publication
(10) Pub. No.: US 2007/0036358 A1
(43) Pub. Date: Feb. 15, 2007

(54) Secure and automatic configuration of wireless networks

(76) Inventors: Bao Thai Nguyen, Fremont, CA (US); Alan Bishop, Groton, MA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/201,610

(22) Filed: Aug. 10, 2005

(51) Int. Cl. H04K 1/00

(52) U.S. Cl. 380/270

(57) ABSTRACT

A first device receives a message over a wired connection from a second device seeking to establish a secure wireless connection with the first device. In response to the received message, the first device exchanges information with the second device and automatically selects a wireless connection configuration. The first device then sends wireless connection information, including information identifying at least a portion of the wireless connection configuration, to the second device over the wired connection. The wireless connection with the second device is enabled in accordance with the selected wireless connection configuration.

### TECHNICAL FIELD

The disclosed embodiments relate generally to configuration of wireless networks. Specifically, the disclosed embodiments relate to automatic configuration of a secure wireless network.

### BACKGROUND

Wireless networking has improved over the past thirty years since it became available for public use. There are many different types of wireless communication devices available. Many employers are utilizing wireless networking in their businesses to provide their employees with access to the internet and/or a local area network (LAN). Additionally, more and more people are also establishing wireless networks in their homes in order to have access to the internet in various areas of their house and share data among various computers or other networking devices. However, for the average home user lacking an extensive knowledge in networking, setting up a functioning wireless home network can prove to be a complicated task.

### SUMMARY OF EMBODIMENTS

In one embodiment, there is provided a method for establishing a secure wireless connection, where a first device receives a message over a wired connection from a second device seeking to establish a secure wireless connection with the first device. In response to the received message, the first device exchanges information with the second device and automatically selects a wireless connection configuration. The first device then sends wireless connection information, including information identifying at least a portion of the wireless connection configuration, to the second device over the wired connection. The wireless connection with the second device is enabled in accordance with the selected wireless connection configuration.

In another embodiment, there is provided a computer program product embodied on a computer-readable medium having stored thereon instructions for execution by a processor in a first device. The stored instructions includes instructions for receiving a message over a wired connection from a second device seeking to establish a secure wireless connection with the first device, instructions for responding to the received message by exchanging information with the second device, instructions for automatically selecting a wireless connection configuration, instructions for sending wireless connection information, including information identifying at least a portion of the wireless connection configuration, to the second device over the wired connection, and instructions for enabling a wireless connection with the second device in accordance with the selected wireless connection configuration.

In another embodiment, there is provided a first device, which includes a processor, a wired connection interface, a wireless connection interface, and memory storing instructions for execution by the processor. The instructions include instructions for receiving a message over a wired connection from a second device seeking to establish a secure wireless connection with the first device, wherein the wired connection terminates at the wired connection interface. The instructions also include instructions for responding to the received message by exchanging information with the second device, instructions for automatically selecting a wireless connection configuration, instructions for sending wireless connection information, including information identifying at least a portion of the wireless connection configuration to the second device over the wired connection, and instructions for establishing a wireless connection with the second device in accordance with the selected wireless connection configuration.

In another embodiment, there is provided a method for establishing a secure wireless connection between a first device and a second device. Upon detecting a predefined device condition, the second device automatically transmits a message to the first device over a wired connection. Upon receiving a predefined reply from the first device, the second devices automatically exchanges information with the first device and receives from the first device wireless connection information via the wired connection. The second device thereafter enables a wireless connection with the first device in accordance with the received wireless connection information.

In another embodiment, there is provided a computer program product embodied on a computer-readable medium having stored thereon instructions for execution by a processor in a client device. The stored instructions include instructions for detecting a predefined device condition, instructions for automatically transmitting a message to a first device over a wired connection, wherein the wired connection is terminated by the wired connection interface, instructions for receiving a predefined reply from the first device, instructions for automatically exchanging information with the first device, instructions for receiving from the first device wireless connection information via the wired connection, and instructions for enabling a wireless connection with the first device in accordance with the received wireless connection information.

In another embodiment, there is provided a client device, which includes a processor, a wired connection interface, a wireless connection interface, and memory storing instructions for execution by the processor. The instructions include instructions for detecting a predefined device condition, instructions for automatically transmitting a message to a first device over a wired connection, instructions for receiving a predefined reply from the first device, instructions for automatically exchanging information with the first device, instructions for receiving from the first device wireless connection information via the wired connection, and instructions for enabling a wireless connection with the first device in accordance with the selected wireless connection configuration.

In another embodiment, there is provided a method for modifying a first wireless communications device that includes a first configuration module for configuring the first wireless communications device in accordance with user provided parameters. The method includes receiving and storing in the wireless communications device a second configuration module. The second configuration module includes instructions for exchanging messages over a wired connection with a second wireless communication device, the exchanged messages include parameters identifying a wireless connection configuration, and instructions for enabling a wireless connection with the second device in accordance with the identified wireless connection configuration.

### BRIEF DESCRIPTION OF THE DRAWINGS

For a better understanding of the invention, reference should be made to the following detailed description taken in conjunction with the accompanying drawings, in which:

FIG. 1A depicts an overview of some components of a wireless communications system.

FIG. 1B also shows a block diagram of a client and a gateway.

FIG. 2A is a block diagram of a wireless communications device.

FIG. 2B is a block diagram further illustrating a memory map of client or gateway.

FIG. 3 is a flow diagram of a process for establishing a wireless connection as performed by a gateway device.

FIG. 4 is a flow diagram of a process for establishing a wireless connection as performed by a client device.

FIG. 5 is a flow diagram of a process for enabling a wireless connection between a client and gateway device.

Like reference numerals refer to corresponding parts throughout the drawings.

### DESCRIPTION OF EMBODIMENTS

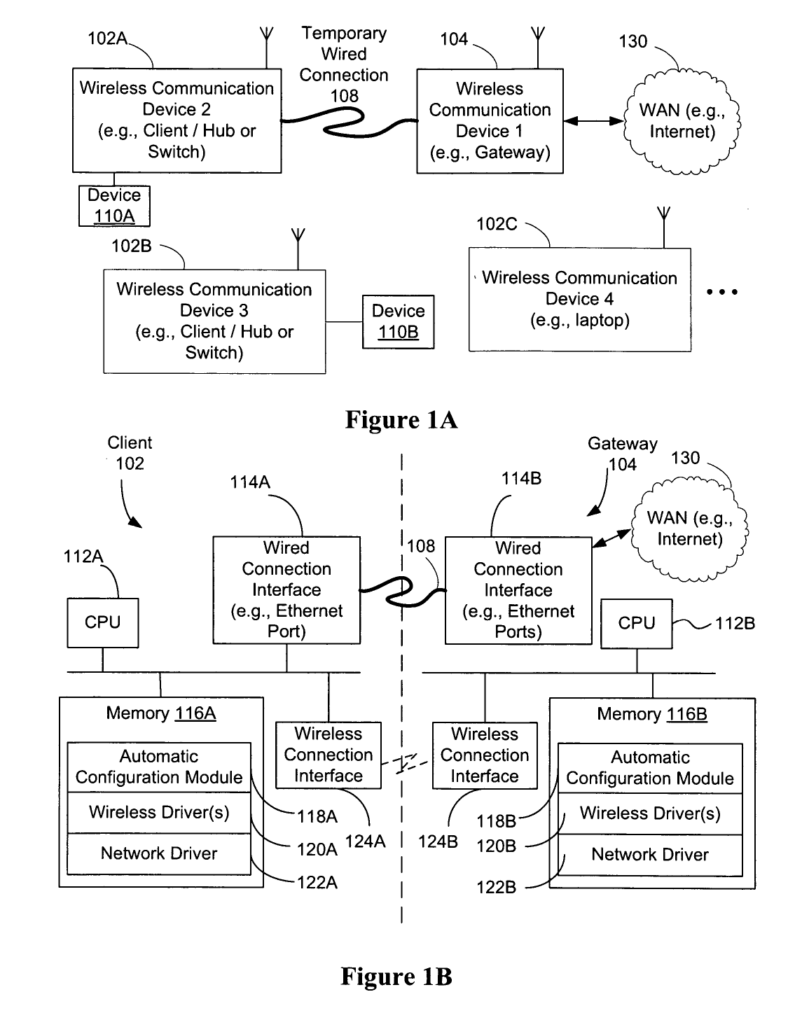

FIG. 1A depicts an overview of some components of a wireless communications system 100. This system 100 may include a first wireless communication device 104, such as a gateway, one or more second wireless communication devices 102A, 102B and 102C, such as a client device, a temporary wired connection 108 for exchanging information, and other devices 110A and 110B, such as laptops or personal computers (PC's). The wireless communications device 102C may also be a laptop configured with wireless networking capabilities. The gateway 104 may be connected a communication network 130, such as the Internet, other wide area network, local area network, metropolitan area network, or any suitable combination thereof. An Internet or other network connection is provided to devices 110A, 110B via the wireless connection formed between the client devices 102 and the gateway 104 and the gateway's connection to the Internet or other communication network.

FIG. 1B also shows a block diagram of a client 104 and a gateway 102. The client 104 generally includes one or more processing units 112A (CPU's), wired connection interface 114A, wireless connection interface 124A, and memory 116A. Similarly, the gateway 102 generally includes one or more processing units 112B, wired connection interface 114B, wireless connection interface 124B and memory 116B. The memory 116A and 116B each include a respective automatic configuration module 118A and 118B, wireless drivers 120A and 120B, and network drivers 122A and 122B, which will be explained in further detail.

In some embodiments, the automatic configuration module 118A in memory 116A of the client device 102 includes instructions for detecting a predefined device condition, instructions for automatically transmitting a message to a gateway device over a wired connection 108, instructions for receiving a predefined reply from the gateway device, instructions for automatically exchanging information with the gateway device, instructions for receiving from the gateway device wireless connection information via the wired connection, and instructions for enabling a wireless connection with the gateway device in accordance with the selected wireless connection configuration.

In some embodiments, the automatic configuration module 118B in memory 116B of the gateway device 104 includes instructions for receiving a message over a wired connection 108 from a client device 102 seeking to establish a secure wireless connection with the first device, wherein the wired connection terminates at the wired connection interface. The instructions also include instructions for responding to the received message by exchanging information with the client device; instructions for automatically selecting a wireless connection configuration, instructions for sending wireless connection information, including information identifying at least a portion of the wireless connection configuration, to the client device over the wired connection; and instructions for establishing a wireless connection with the client device in accordance with the selected wireless connection configuration.

The use of a wired connection to exchange information and configuration information prevents interlopers from eavesdropping while the wireless configuration information is sent to the client, even when the interloper has a compatible client device.

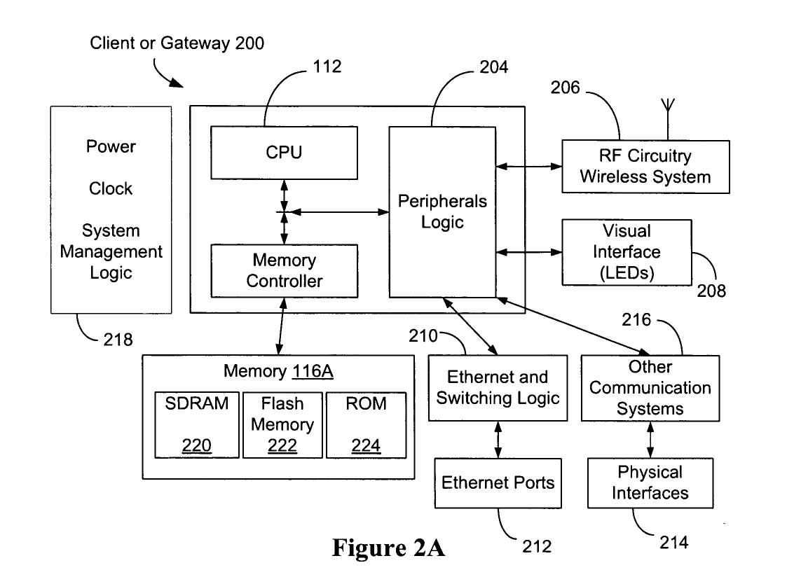

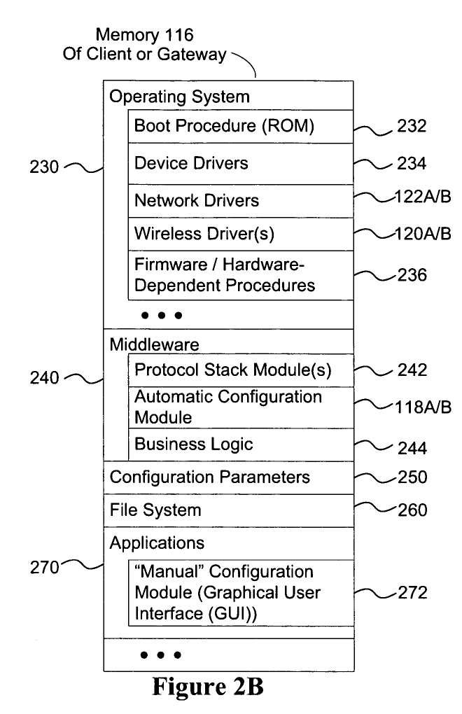

FIG. 2A is a more detailed block diagram of a wireless communications device 200. The device 200 may be either a client or a gateway, although the software and other information stored in the memory of a client device will differ from the software and other information stored in a gateway device. The system 200 generally includes one or more CPU's 112, one or more network or other communications interfaces 210, 216, and memory 116. The system 200 may include peripherals logic 204. The peripherals logic 204 may be coupled to one or more of the following: an RF circuitry wireless system 206, a visual interface 208, such as light emitting diodes (LEDs), Ethernet and switching logic 210, Ethernet ports 212, physical interfaces 214, and other communication systems 216. Memory 116 may include high speed random access memory, such as SDRAM 220, and may also include non-volatile storage such as flash memory 222 and/or read-only memory (ROM) 224. Memory 116 may further include additional non-volatile storage such as one or more magnetic disk storage devices and

or optical disk storage devices. In some embodiments one or more boot procedures (232, FIG. 2B) executed upon device power on or power reset are stored in ROM 224, while other executable procedures and persistently stored data (e.g., configuration parameters) are stored in flash memory 222.

FIG. 2B is a block diagram further illustrating a memory map of client or gateway. Referring to this figure, in some embodiments the memory 116 stores the following programs, modules and data structures, or a subset thereof:
an operating system 230 that includes procedures for handling various basic system services and for performing hardware dependent tasks;
middleware 240;
configuration parameters 250;
a file system 260; and
applications 270, such as a manual configuration module 272.

The operating system 230 may include:
one or more boot procedures 232;
device drivers 234, network drivers 122A or 122B and wireless drivers 120A or 120B for controlling the various peripheral components of the device, such as the peripheral components shown in FIG. 2A; and
other firmware 236 for supporting hardware dependent features and performing hardware dependent tasks.

The middleware 240 may include:
protocol stack modules 242;
an automatic configuration module 118A or 118B; and
business logic 244.

Each of the above identified elements in FIG. 2B may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 116 may store a subset of the modules and data structures identified above. Furthermore, memory 116 may store additional modules and data structures not described above.

The protocol stack modules 242 include procedures or instructions for implementing one or more protocol stack layers in the communication protocol(s) used by the device for wire and wireless communications. Such protocol stacks are well known to those skilled in the art. Business logic 244 may include decision software or logic for controlling the applications executed by the device, controlling manual configuration of the device (e.g., by validating user inputs or selections), determining whether the client is authorized to exchange information with another device, determining whether a new wireless configuration profile is valid to apply to the client device or gateway device determining when and how to apply the settings in a new wireless configuration profile, and the like.

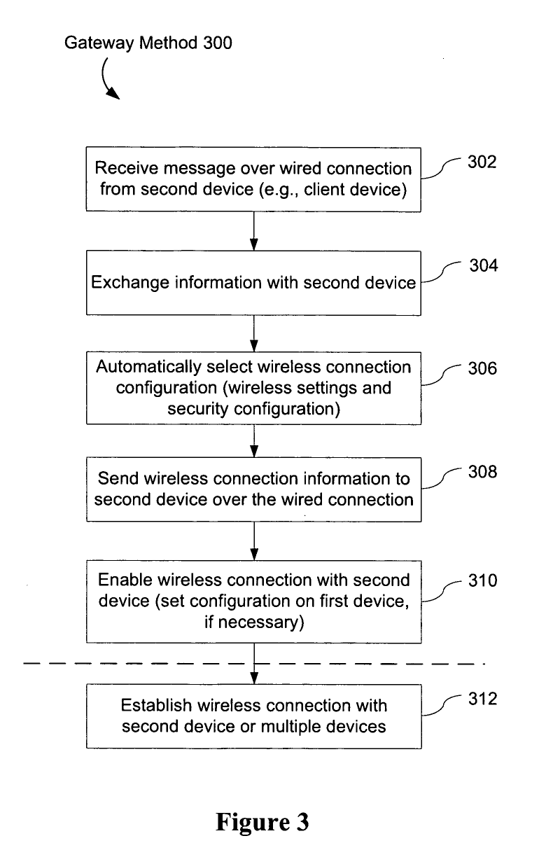

FIG. 3 is a flow diagram of a process 300 for establishing a wireless connection as performed by a gateway device. The gateway listens for a special message from a second device, which is usually a client device, and the process begins by the gateway receiving a message over a wired connection from the client device 302. The two devices then exchange information identifying properties of each device 304. The exchanged information may also include information verifying or authenticating the client device, the gateway device or both. The gateway automatically selects a wireless connection configuration 306, including wireless settings and security configuration. In some embodiments, the gateway selects one or more aspects of the wireless connection configuration in accordance with information received from the client device during operation 304. After selection 306, the gateway sends wireless connection information to the second device over the wired connection 308, and the wireless connection is enabled 310. Subsequently, a wireless connection may be established with the second device or other multiple devices 312 in accordance with the selected wireless connection configuration. It may be noted that the wireless connection information sent to the second device over the wired connection includes at least a subset of the selected wireless connection configuration.

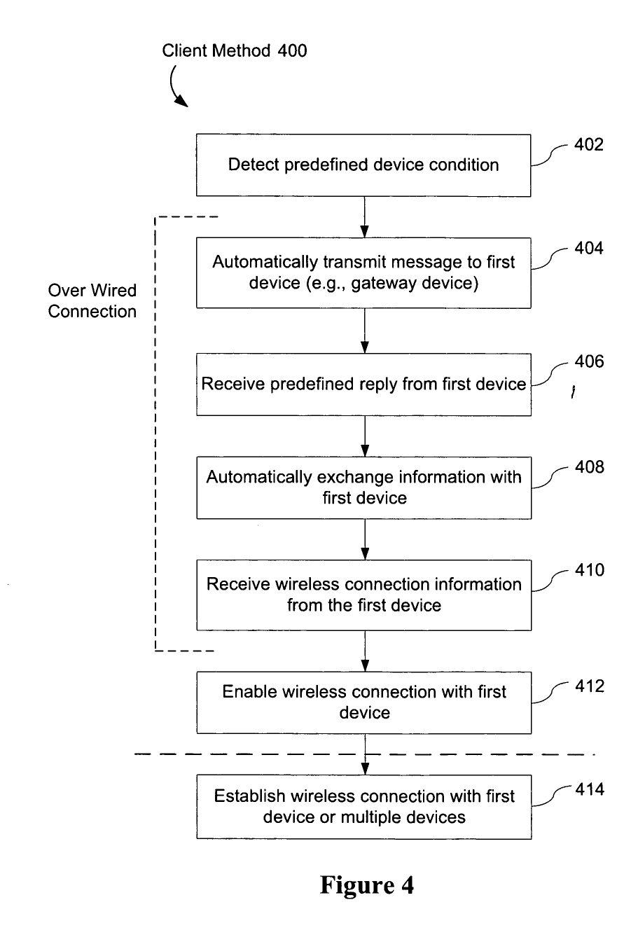

FIG. 4 is a flow diagram of a process 400 for establishing a wireless connection as performed by a client device. The client first detects a predefined device condition 402, such as a power-on condition. Upon detecting the predefined device condition (e.g., power on), the client device broadcasts a predefined message and information 404 seeking a response 406 from the first device, which is usually a gateway device. As described above, the predefined message is broadcast over a wired connection (if one exists) between the client device and the first device. Once a response is received from the first device (406), the client automatically exchanges information with the first device 408. In some embodiments, an initial aspect of the information exchange is an authentication process with the first device to ensure compatibility. If the authentication process fails, the process 400 aborts. Otherwise, if positive authentication is achieved (or if the process does not include authentication), the client device exchanges additional information with the first device 408. The exchanged information may include information that identifies or is otherwise associated with the device, such as device features or capability information. As discussed above with reference to FIG. 3, the gateway selects a wireless connection configuration 306 in accordance with the exchanged information and sends wireless configuration information to the client 308. The wireless configuration information is received 410 by the client, and a wireless connection is enabled 412 in accordance with the received wireless configuration information. Subsequently, a wireless connection may be established with the gateway, and optionally other devices as well, 414, for example by exchanging data and

or protocol packets with those other devices.

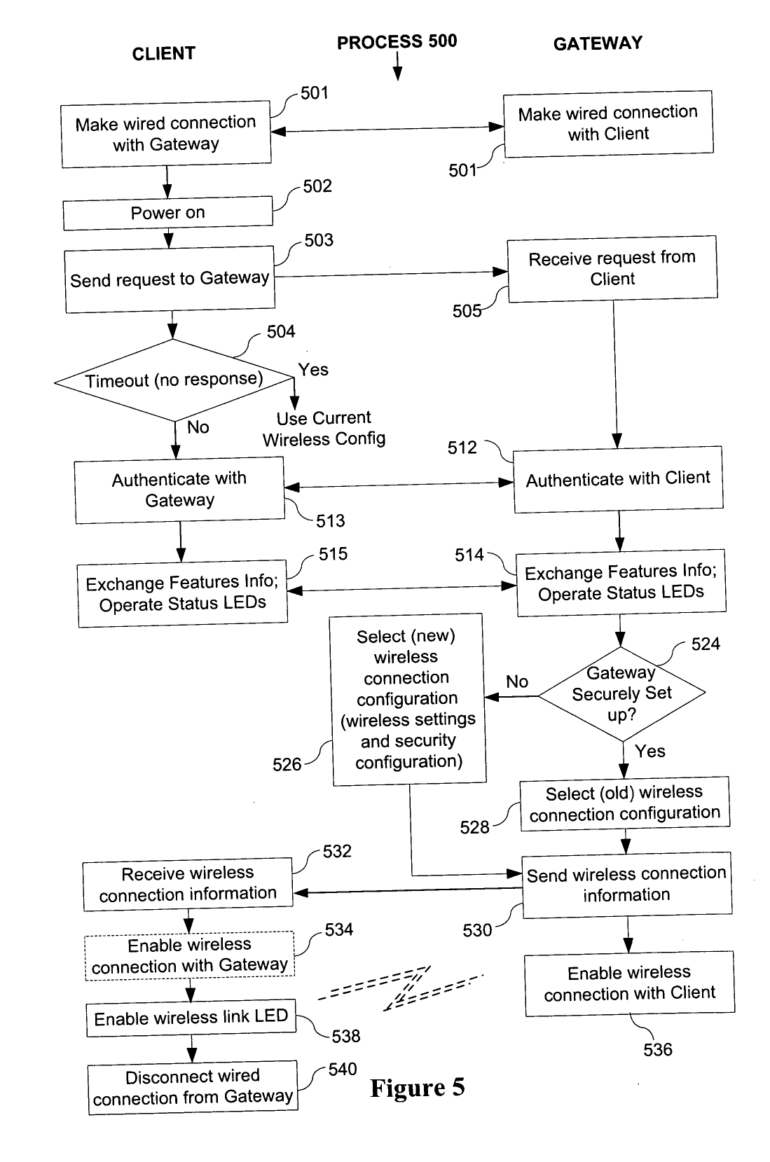

FIG. 5 is a flow diagram of a process 500 for enabling a wireless connection between and a client and a gateway device. The process begins by first making a wired connection between the client device and the gateway device 501. When the client device is powered on 502, it broadcasts information 503 over the wired connection seeking a response from a compatible gateway device. A compatible gateway device is one that is configured to use a wireless configuration process that is the same as, or compatible with, the wireless configuration process used by the client device. A compatible gateway device monitors incoming communications received via its wired connection port(s), looking for a predefined special message from a client. In some embodiments, the predefined special message may be addressed to a predefined IP address, for example, and may contain a predefined command or information to indicate that it is request to initiate the wireless configuration process. The predefined IP address may be a special IP address that is not normally used for any other communications. In these embodiments, compatible gate devices are configured to monitor incoming communications for messages to the predefined IP address.

If the client device does not receive a reply within a predetermined time limit, the process times out and the current wireless configuration is used, if one exists (504-Yes). However, if a reply from a compatible gateway device is received (504-No), an authentication process to ensure compatibility between the gateway and the client device begins (512, 513). At least one challenge is sent from one device to the other. Once the other device successfully responds to challenge, authentication is completed and the devices begin to exchange features information and optionally operate status LEDs (514, 515) to indicate that the wireless configuration process is proceeding.

In some embodiments, the exchanged information includes country information associated with at least the client device and other information regarding configuration and characteristics of the devices. The exchanged information includes information necessary to determine what connection information will be sent from the gateway to the client in order to configure the client device. For instance, the country information sent by the client device indicates the country or countries in which use of the client device is authorized or intended. Some countries have restrictions on the wireless transmission channels used, and/or on the power levels used by wireless devices, and therefore the client device's country information may be taken into account when selecting the transmission channel and/or transmission power level for the wireless connection configuration. After the information is exchanged, there is a determination made regarding whether the gateway is securely set up 524.

In some embodiments, the exchanged information may also include information identifying a set of one or more encryption capabilities of the client device. The gateway may be compatible with a large number of client devices, which may in turn have different encryption capabilities. As a result, the gateway selects a security configuration that is compatible with the particular client device that initiated the configuration process 500. In particular, in some embodiments, the gateway selects a security configuration that uses a most secure encryption methodology that is compatible with both the encryption capabilities of the client device and encryption capabilities of the gateway.

If the gateway is not yet securely set up for wireless communication, or the wireless connection configuration set up in the gateway is not compatible with the client device (524-No), it selects a new wireless connection configuration, including wireless settings and a security configuration 526. The wireless settings may be selected according to the previously exchanged information. These settings may include information identifying a wireless channel, a power setting, an encryption key, and a service set identifier (SSID).

If a second, higher security capable client is later connected to the gateway after a first client with lower security capability has already been connected, the second client will be set up with the same security settings as the first client. However, if the gateway is capable of utilizing the same higher security settings as the second client, and the second client executes the wireless connection configuration process while the first client is turned off, the gateway will then select and enable a wireless configuration based on the higher security settings. If the first client, or any other client with lower security capabilities, is later connected to the gateway for wireless connection configuration while the second client remains turned on, the configuration process will fail because the gateway will retain the higher security configuration established with the second client. The configuration process failure, along with the reason for the failure, may be noted in a log file stored within the gateway. These additional details about operations 524, 526 and 528 are not shown in FIG. 5.

Typically, selecting a security configuration (which is one aspect of the wireless connection configuration) includes selecting an encryption key. In some embodiments, the encryption key is selected or generated in a manner such that the key cannot be predicted by the client device or by an interloper, and thus appears from the viewpoint of the client device or interloper to be random or pseudorandom, even though the process used by the gateway to generate the encryption key may be deterministic. In one embodiment, the encryption key is generated by the gateway as a predefined function of one or more unique identifiers (e.g., a serial number of the gateway and a board identifier or a motherboard or PCB in the gateway) associated with the gateway. Alternately, the encryption key is generated by the gateway using a random or pseudo-random selection method. Similarly, in some embodiments the service set identifier (SSID) for the wireless connection configuration is generated by the gateway using a random or pseudo-random selection method. Furthermore, a radio transmission channel can be chose by either a random or pseudorandom method, or a channel with the least interference may be chosen if the gateway as the ability to scan and evaluate radio interference 526.

Wireless connection information, including the wireless settings and security configuration, is sent to the client 530. After the client device receives the connection information 532 a wireless connection with the gateway may be enabled 534, 536. However, in some embodiments, the wireless connection with the gateway is not enabled until the client device is disconnected from the gateway device 540 (i.e., the wired connection is removed), powered down and restarted. Once the wireless connection has been enabled, the client device optionally enables a wireless link LED on the client device to indicate that wireless connection is available 538.

If the gateway is already securely set up and the previously established wireless connection configuration is compatible with the client device (524-Yes), the gateway selects the previous wireless connection configuration 528 and sends that information to the client 530. Thereafter, the configuration process 500 continues as described above with respect to operations 532 through 540.

Many client devices and gateway devices have the ability to receive software upgrades. The new software is durably stored in flash memory, or other non-volatile memory, typically after the new software has been validated by the device being upgraded (e.g., by validating a digital signature or the like). Client devices and gateway devices that do not include an automatic configuration module 118A or 118B (FIGS. 2A, 2B) can be upgraded to include an automatic configuration module 118A or 118B that operates in accordance with the present invention. Such devices typically include a “manual” configuration procedure 272 (FIG. 2B), which enables users to set the wireless configuration of the device. In some cases, the manual configuration procedure includes a web page or other graphical user interface that is downloaded to a computer via a wired connection such as Ethernet cable or USB cable or the like. This procedure is a “manual” procedure because the user must explicitly select the parameters (e.g., SSID, encryption key or pass phrase, etc.) of the wireless connection configuration.

A method of upgrading a wireless communications device (i.e., a client or gateway device) includes receiving and storing in the wireless communications device a second configuration module 118A or 118B. The second configuration module includes instructions for exchanging messages over a wired connection with a second wireless communication device, the exchanged messages include parameters identifying a wireless connection configuration, and instructions for enabling a wireless connection with the second device in accordance with the identified wireless connection configuration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for establishing a secure wireless connection, comprising:
at a first device:
receiving a message over a wired connection from a second device seeking to establish a secure wireless connection with the first device;
in response to the received message, exchanging information with the second device;
automatically selecting a wireless connection configuration;
sending wireless connection information, including information identifying at least a portion of the wireless connection configuration, to the second device over the wired connection; and
enabling a wireless connection with the second device in accordance with the selected wireless connection configuration.

2. The method of claim 1, wherein
automatically selecting a wireless connection configuration includes automatically selecting an encryption key; and
sending wireless connection information includes sending the selected encryption key to the second device over the wired connection.

3. The method of claim 1, wherein
the exchanged information includes country information; and
automatically selecting a wireless connection configuration includes automatically selecting a wireless channel in accordance with the country information.

4. The method of claim 3, wherein
sending wireless connection information includes sending information identifying the selected wireless channel.

5. The method of claim 1, wherein
the exchanged information includes country information; and
automatically selecting a wireless connection configuration includes automatically selecting a power setting for the wireless connection configuration in accordance with the country information.

6. The method of claim 1, wherein
automatically selecting a wireless connection configuration includes automatically selecting an SSID; and
sending wireless connection information includes sending the selected SSID to the second device over the wired connection.

7. The method of claim 1, wherein
receiving a message over a wired connection from a second device seeking to establish a secure wireless connection with the first device includes receiving information identifying a wireless communications capability of the second device; and
selecting a wireless connection configuration includes selecting a configuration compatible with the identified wireless communication capability of the second device.

8. The method of claim 7, wherein
the identified wireless communication capability comprises a set of one or more encryption capabilities of the second device; and
the selected configuration includes a most secure encryption methodology that is compatible with both the set of one or more encryption capabilities of the second device and a set of one or more encryption capabilities of the first device.

9. A computer program product embodied on a computer-readable medium having stored thereon instructions for execution by a processor in a first device, the stored instructions comprising:
instructions for receiving a message over a wired connection from a second device seeking to establish a secure wireless connection with the first device;
instructions for responding to the received message by exchanging information with the second device;
instructions for automatically selecting a wireless connection configuration;
instructions for sending wireless connection information, including information identifying at least a portion of the wireless connection configuration, to the second device over the wired connection; and
instructions for enabling a wireless connection with the second device in accordance with the selected wireless connection configuration.

10. A computer program product of claim 9, wherein
the instructions for automatically selecting a wireless connection configuration include instructions for selecting an encryption key; and
the instructions for sending wireless connection information from first device include instructions for sending selected encryption key to second device.

11. A computer program product of claim 9, wherein
the instructions for automatically selecting a wireless connection configuration include instructions for selecting an SSID; and
the instructions for sending wireless connection information from first device include instructions for sending the selected SSID to second device.

12. A computer program product of claim 9, wherein
the exchanged information includes country information;
the instructions for automatically selecting a wireless connection configuration include instructions for selecting a wireless channel in accordance with the country information; and
the instructions for sending wireless connection information from first device include instructions for sending information identifying the selected wireless channel to second device.

13. A computer program product of claim 9, wherein
the exchanged information includes country information;
instructions for automatically selecting a wireless connection configuration includes instructions for selecting a power setting in accordance with the country information; and
instructions for sending wireless connection information from first device include instructions for sending information identifying the selected power setting to second device.

14. A first device, comprising:
a processor;
a wired connection interface;
a wireless connection interface; and
memory storing instructions for execution by the processor, the instructions including:
instructions for receiving a message over a wired connection from a second device seeking to establish a secure wireless connection with the first device, wherein the wired connection is terminated by the wired connection interface;
instructions for responding to the received message by exchanging information with the second device, including;
instructions for automatically selecting a wireless connection configuration;
instructions for sending wireless connection information, including information identifying at least a portion of the wireless connection configuration, to the second device over the wired connection; and
instructions for establishing a wireless connection, via the wireless connection interface, with the second device in accordance with the selected wireless connection configuration.

15. A method for establishing a secure wireless connection between a first device and a second device, comprising:
at the second device:
upon detecting a predefined device condition, automatically transmitting a message to the first device over a wired connection;
upon receiving a predefined reply from the first device, automatically exchanging information with the first device;
receiving from the first device wireless connection information via the wired connection;
enabling a wireless connection with the first device in accordance with the received wireless connection information.

16. The method of claim 15, wherein the wireless connection information includes an encryption key, and the wireless connection established is a secure wireless connection that utilizes the encryption key.

17. The method of claim 16, wherein the encryption key is automatically generated by the first device.

18. The method of claim 15, wherein the predefined device condition comprises the first device detecting a power on condition.

19. The method claim 15, wherein the wireless connection information includes a wireless channel selected by the first device.

20. The method claim 15, wherein the wireless connection information includes a SSID selected by the first device.

21. The method claim 15, wherein the exchanged information includes country information; and
wireless connection information includes a power setting for the wireless connection selected by the first device.

22. A computer program product embodied on a computer-readable medium having stored thereon instructions for execution by a processor in a client device, the stored instructions comprising:
instructions for detecting a predefined device condition,
instructions for automatically transmitting a message to a first device over a wired connection, wherein the wired connection is terminated by the wired connection interface;
instructions for receiving a predefined reply from the first device,
instructions for automatically exchanging information with the first device;
instructions for receiving from the first device wireless connection information via the wired connection; and
instructions for enabling a wireless connection, via the wireless connection interface, with the first device in accordance with the received wireless connection information.

23. A computer program product of claim 22, wherein
the instructions for detecting a predefined device condition include instructions for detecting a power on condition.

24. A computer program product of claim 22, wherein
the instructions for receiving from the first device wireless connection information include instructions for receiving an encryption key selected by first device.

25. A computer program product of claim 22, wherein
the instructions for receiving from the first device wireless connection information include instructions for receiving an SSID selected by first device.

26. A computer program product of claim 22, wherein
the exchanged information includes country information; and
the instructions for receiving from the first device wireless connection information include instructions for receiving information identifying a wireless channel selected by first device.

27. A computer program product of claim 22, wherein
the exchanged information includes country information; and
the instructions for receiving from the first device wireless connection information include instructions for receiving information identifying a power setting selected by first device.

28. A client device, comprising:
a processor;
a wired connection interface;
a wireless connection interface; and
memory storing instructions for execution by the processor, the instructions including:
instructions for detecting a predefined device condition,
instructions for automatically transmitting a message to a first device over a wired connection;
instructions for receiving a predefined reply from the first device,
instructions for automatically exchanging information with the first device;
instructions for receiving from the first device wireless connection information via the wired connection; and
instructions for enabling a wireless connection, via the wireless connection interface, with the first device in accordance with the selected wireless connection configuration.

29. A second device of claim 28, further comprising a visual interface, wherein the visual interface is a light emitting diode.

30. A method for modifying a first wireless communications device that includes a first configuration module for configuring the first wireless communications device in accordance with user provided parameters, comprising:
receiving and storing in the wireless communications device a second configuration module, the second configuration module including instructions for:
exchanging messages over a wired connection with a second wireless communication device, the exchanged messages including parameters identifying a wireless connection configuration; and
enabling a wireless connection with the second device in accordance with the identified wireless connection configuration.

31. The method of claim 30, further comprising: prior to the receiving and storing, operating the wireless communications device in accordance with a first configuration determined by the first configuration module.
